(19) United States
(12) Patent Application Publication
(10) Pub. No.: US 2006/0047580 A1
(43) Pub. Date: Mar. 2, 2006

(54) Method of searching, reviewing and purchasing music track or song by lyrical content

(76) Inventor: Diganta Saha, Ann Arbor, MI (US)

Correspondence Address: Diganta Saha, Apt #203, 1695 Broadways Street, Ann Arbor, MI, 48105, US

(21) Appl. No.: 11/214,148

(22) Filed: Aug. 29, 2005

Related U.S. Application Data
(60) Provisional application No. 60/605,707, filed on Aug. 30, 2004.

(51) Int. Cl. G06Q 30/00

(52) U.S. Cl. 705/26

(57) ABSTRACT

Improved method of improving searching, reviewing, purchasing music through the Internet, by searching a song by the lyrical content, intelligently ranking the most relevant search results, reviewing a short audio sample and the option to display the lyrics. Then allowing the user to purchase individual song for electronic download using a single self contained application or within a single website onto the client side Internet enabled device.

### CROSS-REFERENCE TO RELATED APPLICATIONS

This application claims the benefit of provisional patent application Ser. No 60/605,707, filed 2004 Aug. 30^{th} by the present inventor.

### FEDERALLY SPONSORED RESEARCH

Not Applicable

### SEQUENCE LISTING OR PROGRAM

Not Applicable

### BACKGROUND OF THE INVENTION—FIELD OF INVENTION

The present invention relates to an improved method and system for searching, reviewing and purchasing a music track by the lyrical content of a song.

### BACKGROUND OF THE INVENTION—PRIOR ART

Prior purchasing of individual songs (also known as music tracks) on the Internet had disadvantages because one is often unaware of the artist's name, song name, album name or composer's name. This is especially true when one listens to music on the radio or at nightclubs and other venues and the disc jockey frequently neglects to announce the artist name or song name. Similarly, one-cannot learn song titles for music played on the elevator, in a department store, when on hold on the telephone, and in other situations in which a disc jockey absent.

One may be able to discern the era or genre of the song (i.e. seventies, eighties, pop or blues). Although this method of searching results in thousands of possible songs, it does not allow the user to wade through the selections to quickly locate the desired song.

Song names are sometimes named after the most common phrase in the chorus. The user can only remember the most repetitive phrase of the song or, the tune of the song or, at the very least, a few words from the chorus. The user, unable to find a desired song through current online music stores, must resort to typing known phrases of the song into an internet search engine. Using the results produced by the search engine, one can then type the artist's name or song name into the search field of the Internet music store application to locate a song. This two-step process is inefficient, time-consuming and frustrating for the user. The user may give up the pursuit of the desired song. This in turn results in consumer dissatisfaction and a loss of potential business to various online music vendors.

Currently, there exists websites that offer searches based on lyrical databases. However, these websites do not rank search results by relevance criteria, they do not offer audio samples for review, and they do not allow for the purchase of an individual song for direct download onto the user's Internet enabled device. On the other hand, some existing websites with lyrical database search options reference other websites where music can be purchased or they offer music for entire audio compact disc albums instead of an individual songs for download. Because existing websites with lyrical databases do not offer individual songs for direct download and because other existing websites that do offer individual songs for purchase do not have lyrical databases to locate songs, consumers of online music are unable to locate and purchase individual songs quickly and efficiently.

### BACKGROUND OF INVENTION—OBJECTS AND ADVANTAGES

Accordingly, several objects and advantages of the invention are:
(a) To provide the ability to search for a song by lyrical content and rank the possible choices in an intelligent relevance ranking system.
(b) To provide the ability to review the song in a short audio clip sample as well as view the lyrics of the song of choice
(c) To provide the ability to download an individual electronic audio file of the song from a single application or single website, once the desired choice has been made on a phrase or keyword search based on the song's lyrical content.

Further objects and advantages will become apparent from a consideration of the ensuing description and drawings.

### SUMMARY

In accordance with the present invention an Internet music store application or a single website to search for a song by lyrical content, display the search results in an intelligent rank relevance, allow the user to sample a short audio clip of the song and the option to view the lyrics of the song with the phrase or key words in bold or highlighted. Then download the individual audio track on to the user's client side Internet-enabled device like a computer or mobile phone.

### DRAWINGS—FIGURES

FIG. 1. New field of searching by lyrical content added to internet music store purchasing application.

FIG. 2 New field of searching by lyrical content added to internet music store purchasing on web site.

FIG. 3 Illustrates searching for songs with lyrical content “Wild Thing” or similar derivatives and alternatives of typed phrase into the lyrical search criteria, using an Internet Music Store application.

FIG. 4 Illustrates searching for songs with lyrical content “Wild Thing” or similar derivatives and alternatives of typed phrase into the lyrical search criteria, using a web browser.

FIG. 5 Flowchart illustrating the principle behind search by lyric query from the client side Internet Music Store application to the Internet Music Store server.

FIG. 6 Flowchart illustrating the principle behind search by lyric query from the client's web browser to the Internet Music Store server.

### DRAWINGS—REFERENCE NUMERALS

10 Window of internet music store application
11 Any generic web browser
20 Search field entry for lyrics
30 Search button to initiate search online
40 Pull down menu selection for era
50 Pull down menu selection for genre
60 Display area for successful searches ordered by rank relevance
70 Search field entry for Composer name
80 Search field entry for Artist name
90 Search field entry for Song/Track name
100 Search field entry for Album name
110 Uniform Resource Locator (URL) address field
120 Icon displaying a review of the current audio sample playing
121 Add song to shopping cart for check later check out
122 Single action for electronic download using buy song button

### DETAILED DESCRIPTION—PREFERRED EMBODIMENT—FIGS.

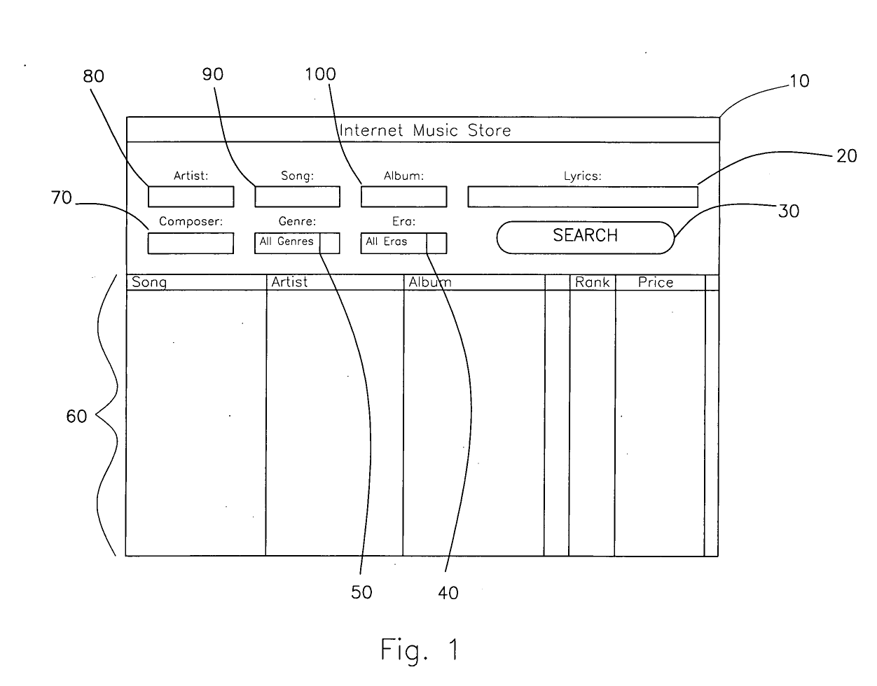

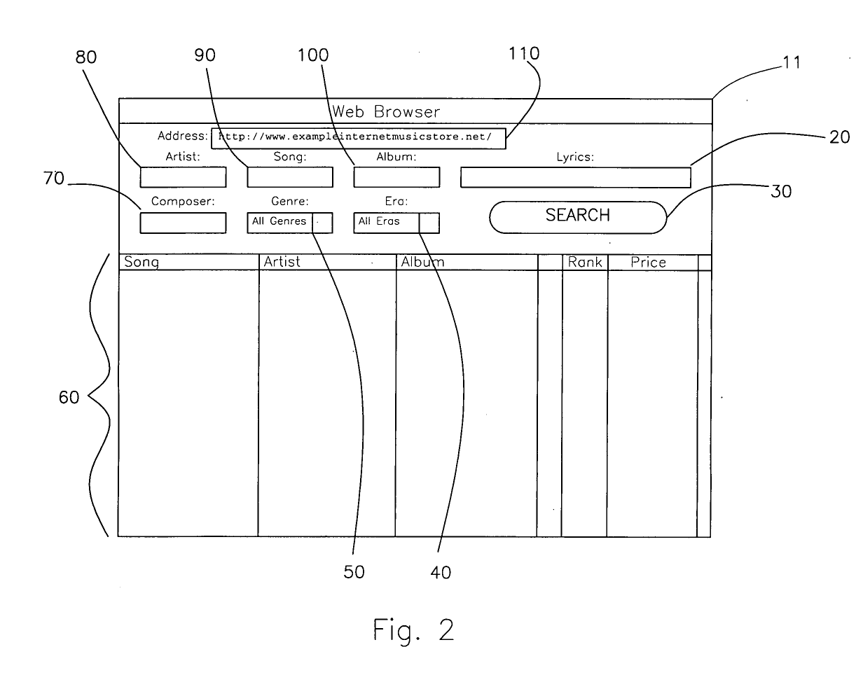

A preferred embodiment of the internet music store application is illustrated in FIG. 1 and the internet music store website FIG. 2. Both of which have the lyric search field 20 added to allow the user to search by phrase or key words, in addition to previously known search criteria artist name 80, song name 90, album name 100, composer name 70, search by genre 50 and search by era 40.

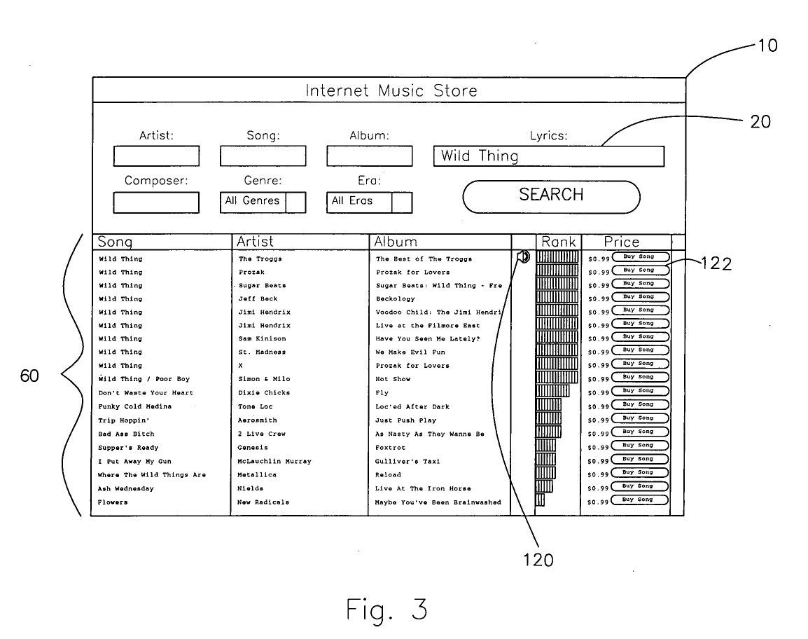

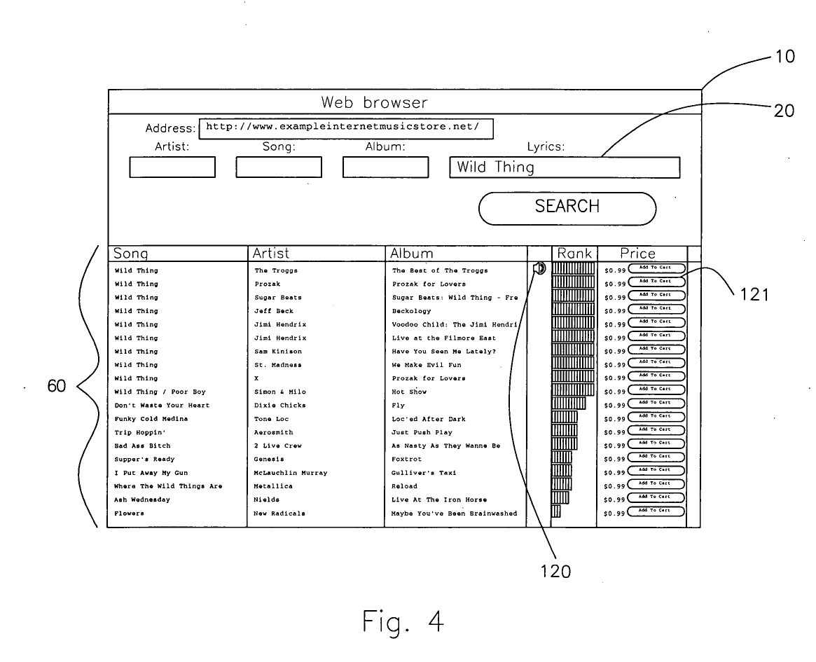

FIG. 3 and FIG. 4 illustrates the successful search result 60 lyrical search for the phrase “Wild thing”, with the ability to sample audio 120 to check that the song being sampled is the correct one and then purchase said song by selecting add to cart 121 or the single action for electronic download using buy song 122.

### OPERATION—PREFERRED EMBODIMENT—FIGS.

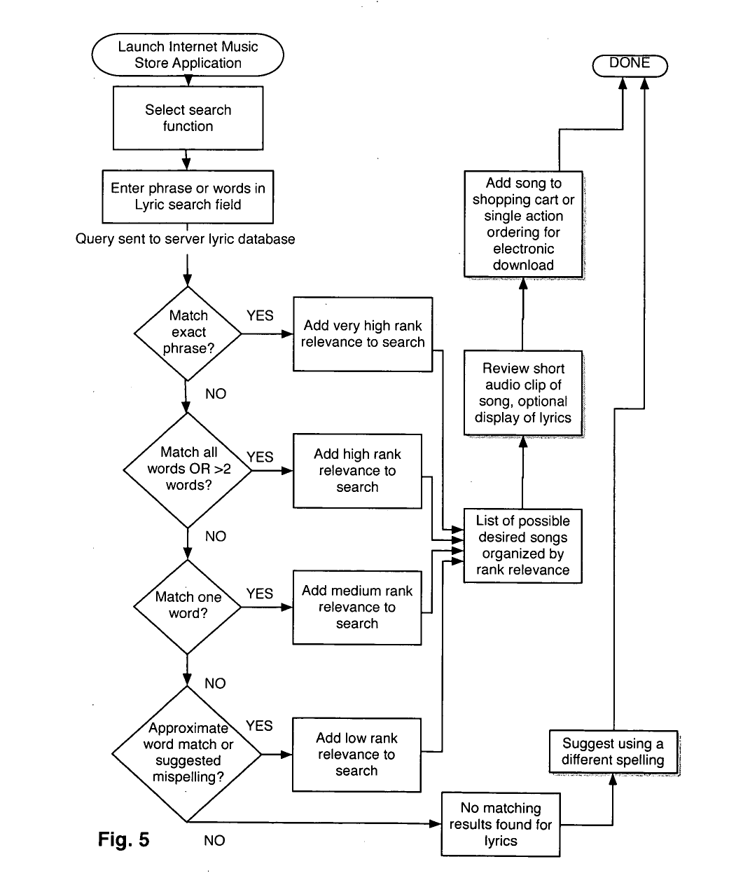

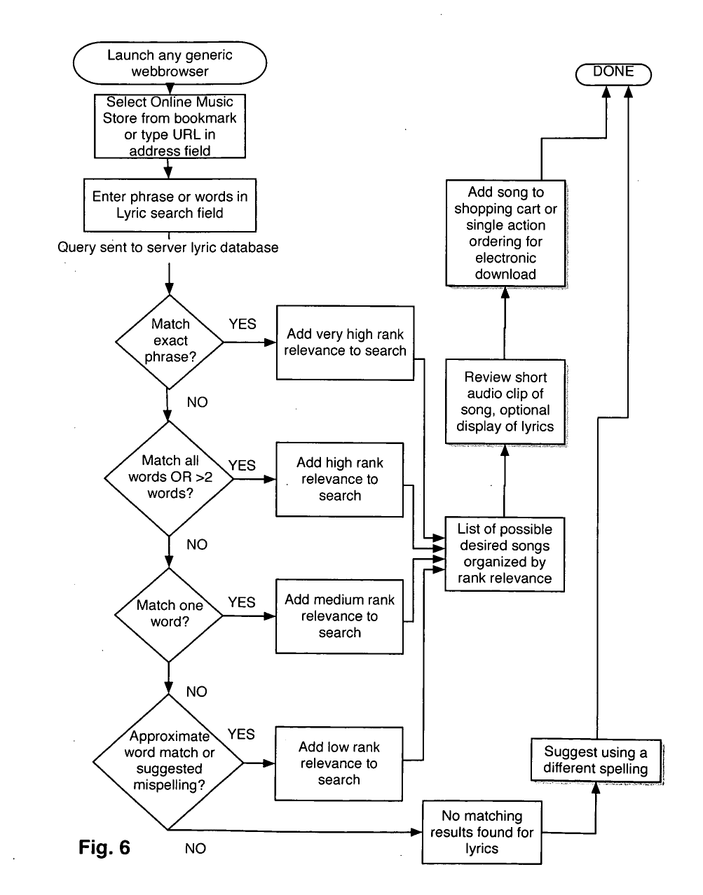

The user launches the application 10 FIG. 5 or web browser 11 FIG. 6. For users using the web browser, they type in the URL of the music store into the address bar 110 or use a previously stored bookmark. Said users then types in phrase or key words into said lyric search field 20. A query is sent to the server and the best results 60 are given returned to client side according to an exact match for the phrase, second best results given to two or more words that match in said song. Medium ranked search result for one word found in song and low rank to a approximation or assumed misspelled key word that resembles one or few words in the song. The user can then sample audio 120 to check that the song being sampled is the correct one and then purchase said song by selecting add to cart 121 or the single action for electronic download using buy song 122.

Operation of searching by phrase or keywords in a lyric database. Here is an example of searching for a song with the phrase “the bombs bursting in air”. Note if the permission is allowed by the artist or respective copyright holder to display the lyric text with the phrase or keywords highlighted or in bold in a separate review window. Example given below,

“The Star-Spangled Banner.”

Oh, say can you see, by the dawn's early light,

What so proudly we hailed at the twilight's last gleaming?

Whose broad stripes and bright stars, through the perilous fight,

O'er the ramparts we watched, were so gallantly streaming?

And the rockets' red glare, the bombs bursting in air,

Gave proof through the night that our flag was still there.

O say, does that star-spangled banner yet wave

O'er the land of the free and the home of the brave?

On the shore, dimly seen through the mists of the deep,

Where the foe's haughty host in dread silence reposes,

What is that which the breeze, o'er the towering steep,

As it fitfully blows, half conceals, half discloses?

Now it catches the gleam of the morning's first beam,

In full glory reflected now shines on the stream:

'Tis the star-spangled banner! O long may it wave

O'er the land of the free and the home of the brave.

And where is that band who so vauntingly swore

That the havoc of war and the battle's confusion

A home and a country should leave us no more?

Their blood has wiped out their foul footstep's pollution.

No refuge could save the hireling and slave

From the terror of flight, or the gloom of the grave:

And the star-spangled banner in triumph doth wave

O'er the land of the free and the home of the brave.

Oh! thus be it ever, when freemen shall stand

Between their loved homes and the war's desolation!

Blest with victory and peace, may the heaven-rescued land

Praise the Power that hath made and preserved us a nation.

Then conquer we must, when our cause it is just,

And this be our motto: “In God is our trust.”

And the star-spangled banner in triumph shall wave

O'er the land of the free and the home of the brave!

All searches by lyrical content will be case insensitive and are ranked by the following rank relevance criteria:

1. Very high rank relevance to exact phrase (all words in correct order), even higher ranking if phrase is repeated several times throughout the song.

“The bombs bursting in air”

2. High rank relevance to all words or more than 2 words found in song (accept for the most common words like “in” and “the”)

“the bursting bombs in air”

3. Medium rank relevance to any word found (accept for the most common words like “in” and “the”)

“bombs” “bursting” “air”

4. Low rank relevance to results that match most words spelt correctly and with only one or two corrective spelling suggestions or spelling alternatives

“The bonbs bursting in the air”; spelling close to bombs

“The bomb burting in air”; spelling close to bursting

Said lyrics of the song can be queried from the server using a central lyric database of choice commercial databases or from the server's native file system, like BeOS BFS™, Mac OS HFS+Spotlight™, Windows Longhorn WinFS™) using metatag/metadata to store this information with each audio file. The server file system can query any audio format with metatag data that can contain lyrics in the ID3 tags. e.g 3GPP and 3GPP2 files that contain TX3G (3G Text temporal data)

### CONCLUSION, RAMIFICATIONS, AND SCOPE

Accordingly the reader will see that, according to the invention, I have provided. While the above description contains many specificities, these should not be construed as limitations on the scope of the invention, but as exemplifications of the presently preferred embodiments thereof. Many other ramifications and variations are possible within the teachings of the invention.
it permits the ease of purchasing a song by lyrical content from a single web site or application
its allows the user to buy individual tracks when searching by lyrical
its allows users to buy download electronic audio files of the a song they desired with the correct lyrical content

For example this method and system could be used to search, review and purchase, then download electronically music videos.

Thus the scope of the invention should be determined by the appended claims and their legal equivalents, and not by the examples given.

1. A single internet music store application or a single internet music store web site comprising:
under control of a client system,
ability to search for a music track by a song's lyrical content,
display a search result in an intelligent rank relevance order,
allow to review said song as a short audio sample,
option to display lyrics of said song,
purchase song by adding to shopping cart or single-action ordering component,
electronically download individual song to the client side device, whereby said purchased song sought was searched by lyrical content, reviewed and purchased from said single internet music store application or single internet music store web site.

2. The method of claim 1 wherein an entire album can be electronically downloaded.

3. The method of claim 1 wherein this can be used on a local music store proprietors intranet.

4. The method of claim 1 wherein lyric search can be done in any language using unicode and not strictly ascii code.

5. The method of claim 1 wherein any client device that can access said internet, like a home entertainment system or a mobile phone.

6. The method of claim 1 wherein said application or said web site can be extended to searching for music videos, movies, television broadcasts, television shows, radio broadcasts, radio shows, audio podcasts, video podcasts based on said lyric, a dialogue, a monologue, commentary, a screenplay to purchase for electronic download.

7. The method of claim 1 of said rank relevance to be further augmented by factoring in song name, composer's name, or artist's name in rank relevance and not exclusively rely on key words or a phrase from said lyrics.

8. The method not to display said lyrics on said web site or said application in text form which can be easily copied to said client side clipboard to comply with copyright requests by individual authors, instead to represent said lyric in a bit mapped image or a vector based image generated by the server side, with highlighted said key words or said phrase in bold.
